(19) United States
(12) Patent Application Publication
(10) Pub. No.: US 2006/0085290 A1
(43) Pub. Date: Apr. 20, 2006

(54) System and Method for Managing Web Based Value Added Content

(76) Inventor: Daniel Pohoryles, Raanana (IL)

Correspondence Address: PATWRITE, P.O. BOX 1663, AMES, IA, 50010-1663, US

(21) Appl. No.: 11/163,384

(22) Filed: Oct. 17, 2005

Related U.S. Application Data
(60) Provisional application No. 60/618,988, filed on Oct. 18, 2004.

(51) Int. Cl. G06F 17/30

(52) U.S. Cl. 705/27

(57) ABSTRACT

An electronic commerce system and method of displaying additional content offered to a user who is in the process of completing a purchase in order to maximize profits. The method determines if additional goods or services should be displayed together with the original order item as a group or should be displayed separately as additional purchasing options or should not be displayed at all. The method is adaptable to both a single vendor and multi-vendor environment.

### RELATED APPLICATIONS

This application claims priority and herein incorporates by reference U.S. provisional patent application No. 60/618,988, filed Oct. 18, 2004.

### BACKGROUND OF THE INVENTION

As home computers systems have gained widespread use, particularly fueled by the services offered on the Internet, customers have become more comfortable in purchasing goods and services online.

Accordingly, many web sites are now providing online stores. In a conventional sale of goods or services on a web site, a catalog of items is presented to the prospective buyer. In general each item of the catalog consists of at least its name, its price, its availability and a “buy” button.

After selecting a catalog item by clicking on the “buy” button, the prospective buyer is transferred to a web-ordering page. This page displays a virtual “shopping cart” which contains the name of the selected item with its price as well as other discounts or charges when appropriate (taxes, shipping charges or other charges).

In conventional “brick and mortar” sales it is expected that after a customer's decision to purchase an item the sales person will offer the customer the possibility to purchase additional goods or services related to the original purchase. For example the shoe sales person will offer the appropriate shoe polish and the waiter in a coffee shop will ask the customer if he cares for a cake to go with the coffee. In the state of the art web-based online sales, customized additional goods and services are also offered when a customer has decided to make a purchase and is transferred to the web-ordering page.

In the “brick and mortar” situation, the sales person is able to assess if it is appropriate to offer an additional item for sale without taking the risk of jeopardizing the initial sale based on the ability to judge the customer feedback. A disadvantage of the online web-based sale is the absence of human interaction that leads to a lack of feedback from the customer. As a result, there is a risk that additional offerings may lead to the loss of the initial sale because they may either distract the customer or create technical difficulties that may prevent the successful conclusion of the sale. Therefore, a need exists for methods to optimize the presentation of the additional offerings so that the vendor will maximize its profit. Such methods should be adaptable to a wide range vendors and sales type.

The present invention is a method and system for deciding where to position related sales items on a web ordering page once a customer has indicated a willingness to make a purchase. The willingness to make a purchase can be indicated by the action taken by the consumer to reach the ordering page. The present invention allows the user to evaluate the probability distribution of converting the willingness to purchase into an active step toward purchasing other value added items from the web ordering page toward the checkout page or toward the next logical page involving a checkout action.

The instant method computes the total profit expected with the above probabilities with a given level of confidence. This expected profit is then used in a function that computes the maximum profit optimization when related items are moved on the display of the web ordering page. More specifically, the initial results are incorporated into a “virtual feedback manager” logic that communicates to the “shopping cart” the related items to be incorporated in the “shopping cart” as opposed to the related items that should be proposed on the web ordering page out of the “shopping cart” or to the related items that should be dropped completely from the ordering page.

### SUMMARY OF THE INVENTION

The invention concerns a method and system for deciding where to position related or value added goods and services on a web ordering page once a customer has indicated a desire to purchase a specific good or service.

It is often the case that good or services related or providing added value to the original item selected may be proposed to the customer. The rational for presenting these additional offerings is to increase the sales and the profits of the vendor by giving more possible value to the customer.

For the vendor, the problem associated with proposing additional offerings is how to do it in such a way that the customer will be encouraged to buy the additional offerings without being deterred from buying the initial item selected.

The present invention presents a method and system of evaluating the willingness on the part of the customer purchasing the initial item and then using these evaluations to

perform “on the fly” positioning of additional offerings on the ordering web page. More specifically, the continuous evaluation of the behavior of the customers is incorporated into a “virtual feedback manager” logic that communicates to the “shopping cart” the additional offerings to be incorporated in the “shopping cart” as opposed to the offerings that should be proposed on the web ordering page out of the “shopping cart” or to the offerings that should be dropped completely from the ordering page.

It is an object of the present invention to maximize single vendor's or multiple vendors' profit.

It is another object of the present invention to decrease consumer uncertainty.

Other features and advantages of the instant invention will become apparent from the following description of the invention which refers to the accompanying drawings.

### BRIEF DESCRIPTION OF THE DRAWINGS

FIG. 1 is a flow chart illustrating the prior art of a generic order process on an online web store.

FIG. 2 is a flow chart illustrating an order process on an online web store according to an embodiment of the present invention.

FIG. 3 is a diagrammatic view illustrating an example of a web ordering page for a software product with many related items in cart according to an embodiment of the present invention.

FIG. 4 is a diagrammatic view illustrating an example of a web ordering page for a software product with a single related item in cart according to an embodiment of the present invention.

FIG. 5 is a diagrammatic view illustrating an example of a web ordering page for a software product with many related items out of the cart according to an embodiment of the present invention.

FIG. 6 is a diagrammatic view illustrating an example of a web ordering page for a software product with a single related item out of the cart according to an embodiment of the present invention.

FIG. 7 is a diagrammatic view illustrating an example of a web ordering page for a software product with hidden related items out of the cart and a link pointing to these related items according to an embodiment of the present invention.

FIG. 8 is a diagrammatic view illustrating an example of a web ordering page for a software product without related items according to an embodiment of the present invention.

### DETAILED DESCRIPTION OF THE INVENTION

Reference will now be made in detail to embodiments of the present invention, examples of which are illustrated in the accompanying drawings. While the invention is described by specific embodiments, it is understood that the description is not intended to limit the invention to these embodiments, but is intended to cover alternatives, equivalents, and modifications.

Although the present invention is described using a sale of a software package in a single or multi-vendor environment, the present invention works well with the sale of other goods such as books, electronic books, movies, records and many other goods which may be associated with other goods or services adding value to the original item being sold.

The web pages described below may be located on a single web server or on different web servers. Some of the pages requiring the filling of sensitive personal or financial information are located on secure web servers while others may not.

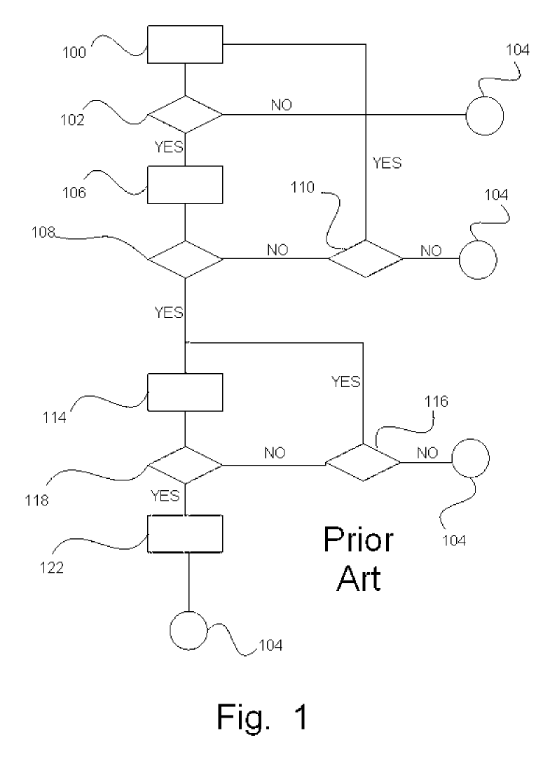

Referring to FIG. 1, a customer first sees a list of items located on a catalog or other offering type page 100. The customer will either select an item 102 and be transferred to a web ordering page 106 or the customer will exit 104 the web store. If the customer is transferred to the ordering page 106, he or she will either decide to go to the checkout 108 and then to a personal information and financial information page (PIFI page) 114 or will continue shopping 110 or will exit 104 the web store. When the customer fills in the required information on the PIFI page 114 and is validated 118, he or she is then transferred to a confirmation page 122 and then exits 104 the web store. If the payment is not validated 118, the customer is given an opportunity to correct the information 116 or to exit 104 the web store.

It should be noted that page 100 is merely an example and it is quite common that the catalog will be located on a multiple pages. Similarly it is quite common that the PIFI page 114 be multi-page input with some pages collecting personal information and other pages used to collect financial information.

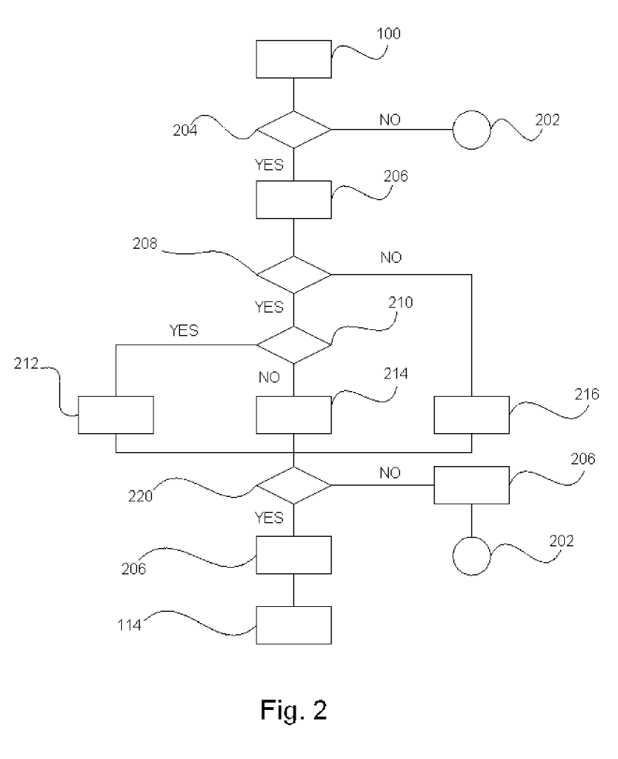

Referring now to FIG. 2, a flowchart represents the buying experience of a customer utilizing the present invention. As before, the customer enters the catalog page 100 and decides whether to buy an item 204 or exit the web store 202. If the customer clicks on the buy button 204, a feedback manager 206 receives the input and decides whether to add a value added item 208 or to go straight to a web order page 216 that has no other items except the original selection 204. If the feedback manager 206 decides 208 to add items 210, the can either be placed on the web order page 212 or on a separate web order page 214. The feedback manager 206 comprises a computer program with its associated data storage (not shown.) The feedback manager 206 is responsible for sending the commands used to generate the order pages 212, 214 or 216. The feedback manager 206 also accumulates data on the probable behavior of a consumer once he or she has selected a specific item, and uses this expected behavior in order to position additional offerings on the web order pages 212, 214 or 216.

The positioning of the additional offerings on the web order pages 212, 214 or 216 is important because experimental studies that I have performed showed that the probability of purchasing additional offerings is substantially higher when the additional offerings are placed in the cart than when they are placed outside of the cart.

The feedback manager 206 also gathers data after deciding on an option to present the customer with based on the customer's response. If the customer decides 220 to leave the web order page 212, 214 or 216 without completing the purchase, the feedback manager 206 records this decision and adds this input to its data base and directs the customer to exit 202. Likewise, if the customer continues to the PIFI page 114, the feedback manager 206 records this action as well.

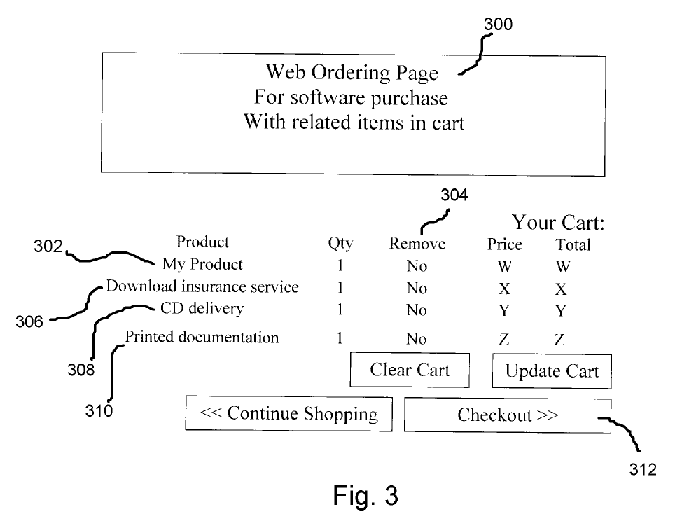

Now referring to FIG. 3, a “virtual shopping cart” 300 is shown in diagrammatic form where additional offerings 306, 308 and 310 have been placed in the cart 300. In this cart 300 all the offerings 306, 308 and 310 may belong to a single vendor or to multi-vendor. It is possible to have a basic software product 302 offered by a publisher, a download insurance service 306 by an outside service specializing in insurance, and a CD 308 offering subcontracted to another service provider as well as printed documentation 310. In this case, a customer who does not want an additional offering 306, 308 and or 310 is required to remove it 304 from the shopping cart 300 before proceeding to checkout 312.

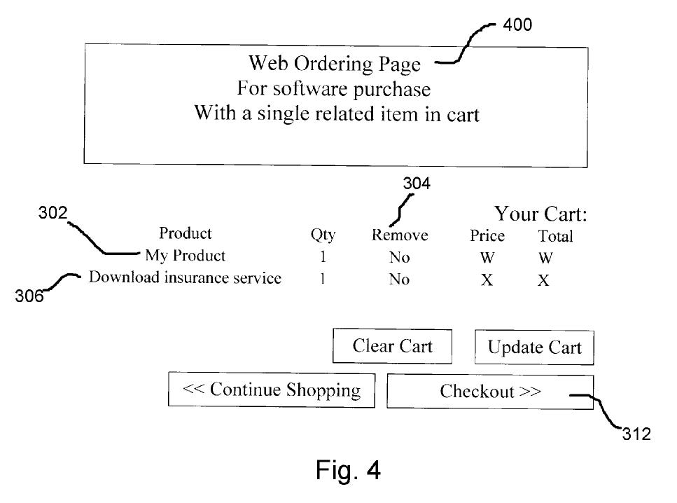

With reference to FIG. 4, a diagrammatic view of a shopping cart 400 with only the single additional offering 306 placed in the cart 400. In this cart 400 both offerings 302 and 306 may belong to a single vendor or to multi-vendor as discussed above. Again, in this case, a customer who does not want the additional offering 306 must click on the remove 304 button before continuing to the checkout 312.

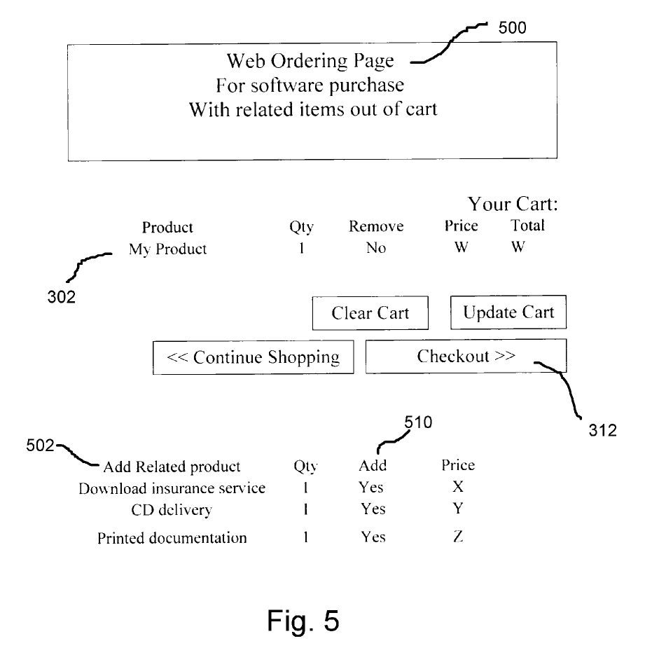

Now referring to FIG. 5, a diagrammatic view of a shopping cart 500 with additional offerings 502 displayed “off cart.” That is a customer who wants to add an offered product or service must add them to the cart 500. In this case the cart 500 appears only with the basic software product 302 selected and the additional offerings 502 appearing on the bottom of the ordering page. In this case, if a customer wants to add an additional offering 502, he or she needs to click on the corresponding checkbox 510 before proceeding to checkout 312.

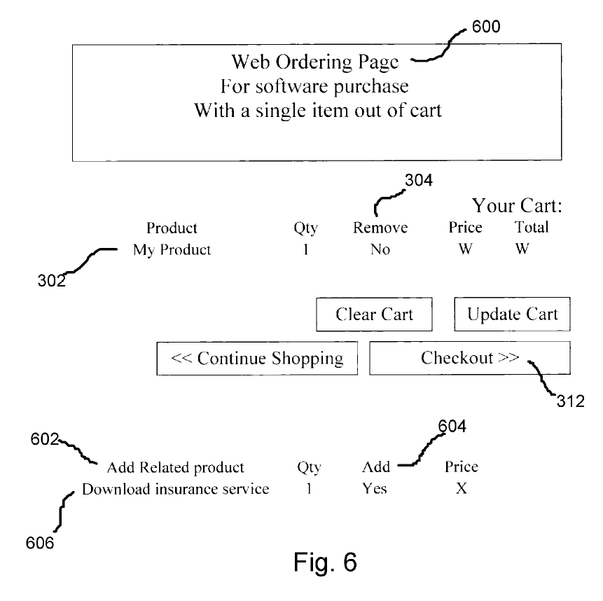

FIG. 6 represents a shopping cart 600 with only with the basic software product 302 selected and a single additional offering 602 appears on the bottom of the ordering page. In this case, if a customer wants to add the additional offering 602 he or she needs to click on the corresponding checkbox 604 before proceeding to checkout 312.

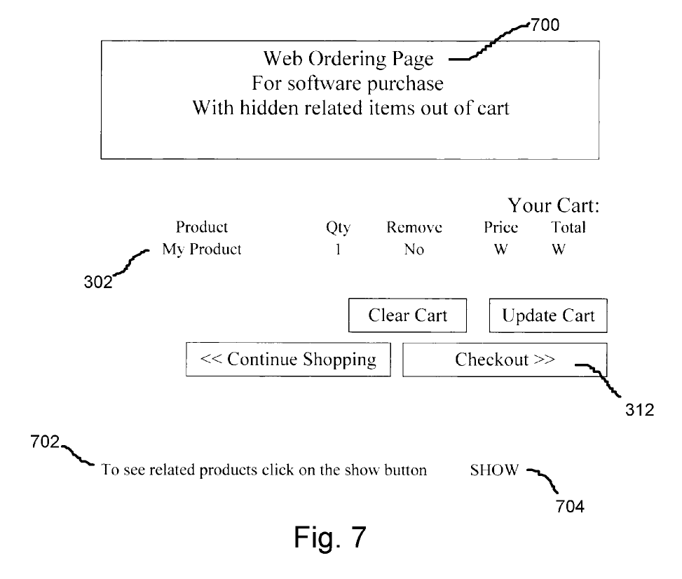

Referring to FIG. 7, a shopping cart 700 is represented, but in this case the cart 700 appears only with the basic software product 302 selected and the additional offerings 702 are hidden at the bottom of the ordering page. In this case, when a customer wants to add an additional offering he need first to click on a button or hyperlink 704 to discover the additional offerings 702 and then to click on the corresponding checkboxes (not shown) before continuing to checkout 312. This method of presentation may be the least distractive for presenting additional offerings to the customer but it may also generate the smaller sales.

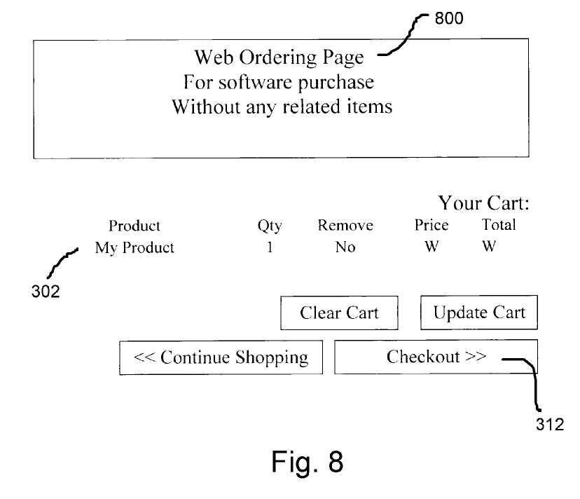

Now referring to FIG. 8, a shopping cart 800 is shown having only the basic software product 302 selected with no additional offerings before proceeding to checkout 312.

Referring now to FIGS. 2 through 8, feedback manager 206 first gathers statistical data that will be used in the daily operation of the present invention. This phase is called the “initialization phase” of the feedback manager 206 consists of a number of experiments in which the feedback manager 206 will order to the web server to show the various web ordering pages.

It would be optimum to perform the experiments for each item proposed in the catalog. However, if sales of each item are low, it may not be possible to gather enough data for each item so that significant statistics would be generated having the necessary level of confidence. In the case described, statistics could be gathered for all items together without discriminating between items and then use an average value. When computing the profit function later, this average could be used for the prices of the items as well as the profit margin. In one embodiment of the present invention, we describe gathering the statistics for each item, but we have also conducted experiments where we have gathered statistics for the whole web store without discriminating between each item.

In use, it is necessary to establish a baseline probability of having the customer move from the web ordering page 216 to the PIFI page 226 without any additional offerings as described in FIG. 5. This probability is established for each item selected in the catalog when no additional offerings are presented to the customer. The establishment of this probability can in general be achieved with a desired level of confidence based on historical data. If historical data is not available, then data can be gathered until a level of confidence is reached that is acceptable.

Once the baseline probability is established, it is necessary to define a time period for each item. The time period is dependant on the number of specific items that are expected to be selected in the web store catalog. The time period is defined so that the number of expected selections will be sufficient to give at least significant statistics at the confidence level defined above.

Once the baseline probability and the time period have been established, the probability of having the customer move from the web ordering page 212 to the PIFI page 226 with one additional offering 306 in the cart 400 as described in drawing 4 must be determined. In order to find the probability, the feedback manager 206 orders the web server to show only page 212 for each product until the time period is completed. During this phase, the feedback manager 206 is also gathering data to establish the probability that a customer will move to PIFI page 226 with the additional offering 306 still in the cart 400.

Once the baseline probability and the time period have been established, it is also necessary to find the probability of having the customer move from the web ordering page 214 to the PIFI page 226 when presented with the additional offering 606 in the bottom of the page as described in FIG. 6. In order to find this probability the feedback manager 206 orders the web server to show only page 214 for each product until the time period is completed. At this phase, the feedback manager 206 is also gathering data to establish the probability that a customer will move to PIFI page 226 after having added the additional offering 606 to the cart 600.

At this stage the initialization phase of the feedback manager 206 is complete and has gathered the expected values of the variables needed to formulate the profit function for each item (or for all the web store.) This is called the baseline values.

Next, a baseline profit is computed. The baseline profit is defined by the formula PR₀=N*q₀*P₁*(1−c₁) when N is the number of times a customer has arrived to page 200, q₀ is the probability of proceeding to PIFI page 226 when a customer is on page 200, P₁ is the price of the selected item and c₁ is the percentage of the profit paid to the store in order to sell the selected item.

In one embodiment, a single vendor controls the web store, the catalog and the additional offerings. In this embodiment, only one additional offering will be shown in order to simplify the method, but the invention works as well for multiple additional offerings.

In the embodiment above, the profit function is computed for a single vendor and then the feedback manager 206 is programmed to maximize the profit function.

The profit function is defined as PR₁=N₁*((q₁*(1−c₁)*P₁)+(q₁*(1−d₁)*e₁*P₂))+N₂*((q₂*(1−c₁)*P₁)+(q₂*(1−d₁)*e₂*P₂)) where we define the following variables: N₁ is the number of times a customer arrives at the ordering page 214, N₂ is the number of times a customer arrive to the ordering page 212, q₁ is the probability to proceed to page 226 when a customer is on page 214, q₂ is the probability to proceed to page 226 when a customer is on page 212, c₁ is the percentage of the profit paid to the store in order to sell the selected item, d₁ is the percentage of the profit paid to the store in order to sell the additional item, P₁ is the price of the item selected (or the average price of all items if they are not considered separately), P₂ is the price of the additional item selected (or the average price of all items if they are not considered separately), e₁ is the probability to add the additional offering to the cart in page 214, and e₂ is the probability not to remove the additional offering from the cart on page 212.

It is easy to see that the profit function reduces to a function of type PR₁=N₁*a+N₂*b. In this case the feedback manager 206 will behave according to the following rules: if a>b then select page 214 as a candidate to be shown and compute PR₁ as PR₁=N*a and if a<b then select page 212 as a candidate to be shown and compute PR₁ as PR₁=N*b.

Then we compare the projected profit with an additional offering to the initial baseline profit (without any additional offering on the page). If the computed PR₁ is greater than PR₀ then the page with the additional offering brings more profit than the initial page and the feedback manager 206 will show page 214 if a>b and it will show page 212 if a<b. If the computed PR₁ is lower than PR₀ then the page with the additional offering brings less profit than the initial page and the feedback manager 206 will show page 216.

The feedback manager 206 will continue to accumulate statistical data during each time period. At the end of each time period the probabilities accumulated during the time period will be compared to the baseline values and if they differ significantly from the baseline values, then new baseline values will be established according to the procedures outlined above.

It is also possible to reevaluate the baseline values if a significant change in traffic in the web store is detected or once during a fixed period that a vendor feels a need for some verification of the validity of the baseline values (this may be once a year for example).

In another embodiment, two vendors cooperate to maximize profits in a mutually beneficial implementation. One of the vendors is the publisher of the software package and he or she controls what will be shown on the web ordering page or where additional offerings will be positioned on the ordering page, but the additional offerings belong to the other vendor.

The embodiment described above is very common in the shareware industry, as many publishers outsource the payment part of the registration to specialized companies and the registration companies are paid a percentage of the sale. Typically, the customer sees the software package specifications and descriptions in the web site of the shareware publisher and when the customer wants to buy, he or she is transferred to a secure web site operated by the company handling the registration. This transfer may occur at the catalog page 200 or at the ordering pages 212, 214 or 216.

Often in this situation, the registration companies offer additional services on the ordering page. The price of these additional services is generally computed in two different ways: either the software publisher buys the service from the registration company at a fixed price and adds a mark-up on the initial price, or the registration company controls the price of the service and pays a fixed percentage of each sale of the service to the software publisher.

In general, the software publisher will control if or where the additional offerings will be positioned on the web ordering page. However, the software needed to show the selected good or service and the additional offerings will reside on a server of the registration company and will be under the responsibility of the registration company.

In this embodiment we have two profit functions: the profit function for the software publisher which is PR₁=N₁*((q₁*(1−c₁)*P₁)+(q₁*(1−d₁)*e₁*P₂))+N₂*((q₂*(1−c₁)*P₁)+(q₂*(1−d₁)*e₂*P₂)) and the profit function for the registration company which is: PR₂=N₁*((q₁*c₁*P₁)+(q₁*d₁*e₁*P₂))+N₂*((q₂*c₁*p₁)+(q₂*d₁*e₂*P₂)).

It is easy to see that the profit function of the software publisher reduces to a function of type PR₁=N₁*a+N₂*b and that the profit function of the registration company reduces to a function of type PR₂=N₁*c+N₂*d.

In this embodiment, the feedback manager 206 needs to be programmed differently that in the embodiment of a single vendor. The first step is still to check if the computed PR₁ is lower than PR₀. If this is the case, the page with the additional offering brings less profit than the initial page and the feedback manager 206 will show page 216.

If the computed PR₁ is greater than PR₀, then there are two basic cases. In the first case the profit function of the software publisher and the profit function of the registration company are going in the same direction. These are the cases where a<b and c<d or where a>b and c>d. In these cases the decision of the software vendor will be similar to the case of the single vendor and the feedback manager will be programmed according to the logic described above.

In the second case the profit function of the software publisher and the profit function of the registration company are not going in the same direction. In this case the software publisher may select to position the additional offerings in a way that will not bring maximum profit to the registration company. These are the cases when a<b and c>d or when a>b and c<d.

In the case where the profit function of both vendors are not going in the same direction, the logic of the feedback manager 206 has to be refined in order to bring the best profit available to both vendors. That is both vendors will achieve a higher profit by cooperating than they would if the software publisher decided on its own.

In this case it is possible to negotiate various rates to satisfy both vendors. This may be done by holding discussions between the two vendors and is also be helped by programming the feedback manager 206 to take this case into account automatically and compute new rates dynamically.

In the case where the profit function of both vendors are not going in the same direction, we compute the “potential loss” of the registration company and the “potential gain” of the software publisher. If the “potential loss” of the registration company is larger than the “potential gain” of the software publisher, then it is sometimes possible to improve the maximum profit of both vendors by transferring “potential profit” from the registration company to the software publisher until it becomes worthwhile to the software publisher to change the position of the additional offerings on the web ordering page.

In the case where a>b and c<d, the software publisher would select page 214; therefore; we can compute the potential loss of the registration company as: PL=d*N−c*N. We can also compute the potential gain of the software company as PG=a*N−b*N. If PL>PG, it is worthwhile for the registration company to move DP potential earnings to the software publisher all the time than PL>DP. Obviously we also need that DP>PG otherwise this is not worthwhile for the software publisher to change the position. Obviously the registration company is interested maximizing its profit so it would like to move DP=PG+1. Since the computations are based on probabilities, it is also possible to split the “potential profit” for both by having DP=(PL−PG)/2. In this case after computing DP we will get DP=(P₁*(q₂−q₁)+P₂*(q₂*e₂−q₁*e₁)*N)/2.

In the case where there is the possibility to split the “potential profit,” then the feedback manager 206 will compute the appropriate value of d₁ which will correspond to the strategy adopted for DP (either PG+1 or any value such that DP>PG+1 and DP<PL).

Another implementation of the present invention occurs when the profit function of both vendors are not going in the same direction. The feedback manager 206 can compute the maximum penalty the registration company would see to change the ordering on the page. The feedback manager 206 would have a credit when starting to show pages and it will show page 212 all the time the credit is positive and would switch to page 214 when the credit reaches zero. This implementation would insure that the software publisher will always have a higher profit than if deciding alone and at the same time it will give a higher profit to the registration company while controlling its risks.

The present invention may be realized in software with various operating systems and run on various hardware. Any kind of computer system adapted for carrying out the methods described herein is suited.

Although the instant invention has been described in relation to particular embodiments thereof, many other variations and modifications and other uses will become apparent to those skilled in the art.

What is claimed is:

1. A method for managing display of a web based ordering page in response to user input comprising the steps of:
accessing a web page containing user selectable information;
selecting at least one of said user selectable information;
communicating with a feedback manager wherein said feedback manager selects an appropriate page for viewing by said user;
storing data related to said user selection;
manipulating the data in accordance with an algorithm stored in a computer; and
adjusting a future action based on the results of said data manipulation.

2. A method for managing display of a web based ordering page in response to user input according to claim 1 further including the step of:
gathering user information for use in establishing a baseline in order to determine the probability of having users select at least one value added selection.

3. A method for managing display of a web based ordering page in response to user input according to claim 2 wherein said step of gathering user information for use in establishing a baseline includes a user selectable time period.

4. A method for managing display of a web based ordering page in response to user input according to claim 3 wherein said algorithm uses a formula to determine the profitability of offering said user at least one value added selection.

5. A method for managing display of a web based ordering page in response to user input according to claim 4 wherein said at least one value added selection is provided from a single source site.

6. A method for managing display of a web based ordering page in response to user input according to claim 4 wherein said at least one value added selection is provided from multiple source sites.

7. A method for managing display of a web based ordering page in response to user input according to claim 5 wherein said at least one value added selection is provided as an opt out selection.

8. A method for managing display of a web based ordering page in response to user input according to claim 6 wherein said at least one value added selection is provided as an opt out selection.

9. A method for managing display of a web based ordering page in response to user input according to claim 7 wherein said opt out selection is displayed within a single page.

10. A method for managing display of a web based ordering page in response to user input according to claim 8 wherein said opt out selection is displayed within a single page.

11. A method for managing display of a web based ordering page in response to user input according to claim 5 wherein said at least one value added selection is provided as a link to an additional page in response to communication from said feedback manager.

12. A method for managing display of a web based ordering page in response to user input according to claim 6 wherein said at least one value added selection is provided as a link to an additional page in response to communication from said feedback manager.

13. A method for managing display of a web based ordering page in response to user input according to claim 2 wherein said feedback manager calculates a baseline value.

14. A method for managing display of a web based ordering page in response to user input according to claim 13 wherein said feedback manager calculates a baseline profit.

15. A method for managing display of a web based ordering page in response to user input according to claim 13 wherein said baseline profit is calculated a baseline profit formula.

16. A system for managing display of a web based ordering page in response to user input comprising:
a web site for managing a user selection screen; and
a feedback manager for determining a user's tendency to select additional content;
said feedback manager comprising instructions readable by a computer along with associated data storage for accumulating data on the probable behavior of future users;
a means of displaying a result of said feedback manager's determination to said user.

17. A system for managing display of a web based ordering page in response to user input according to claim 16 wherein said means of displaying said result includes an opt out value added selection displayed within a single page.

18. A system for managing display of a web based ordering page in response to user input according to claim 16 wherein said means of displaying said result includes an opt out value added selection displayed on at least one additional page.

19. A system for managing display of a web based ordering page in response to user input according to claim 16 wherein said feedback manager includes a baseline calculation.

20. A system for managing display of a web based ordering page in response to user input according to claim 19 wherein said feedback manager includes a profitability calculation.
